(19) United States
(12) Patent Application Publication
(10) Pub. No.: US 2026/0184140 A1
(43) Pub. Date: Jul. 2, 2026

(54) VEHICLE AND WINDSHIELD

(71) Applicant: KAWASAKI MOTORS, LTD., Hyogo (JP)

(72) Inventors: Justin OLSON, Lincoln, NE (US); John RAMEY, Lincoln, NE (US)

(73) Assignee: KAWASAKI MOTORS, LTD., Hyogo (JP)

(21) Appl. No.: 19/292,919

(22) Filed: Aug. 7, 2025

Related U.S. Application Data
(60) Provisional application No. 63/739,302, filed on Dec. 27, 2024.

(51) Int. Cl. B60J 1/06; B60Q 1/04

(52) U.S. Cl. CPC B60J 1/06; B60Q 1/0483; B60Q 2800/20

(57) ABSTRACT

A utility vehicle includes a windshield. The windshield includes an upper panel, a lower panel, and a hinge coupling the upper panel and the lower panel to each other such that the upper panel and the lower panel are allowed to be folded or unfolded. In a state where the upper panel and the lower panel are unfolded, the hinge is positioned either parallel to a horizontal plane or tilted relative to the horizontal plane such that a front side of the hinge is tilted toward the lower panel.

### CROSS-REFERENCE TO RELATED APPLICATION

This application claims priority to U.S. Provisional Application No. 63/739,302 filed on Dec. 27, 2024, the entire disclosure of which is incorporated herein by reference.

### FIELD

The technique disclosed here relates to a vehicle and a windshield.

### BACKGROUND

U.S. Patent Application Publication No. 2002/0084669 discloses a vehicle including a windshield.

### SUMMARY

A vehicle disclosed here is a vehicle including a windshield, and the windshield includes the windshield includes an upper panel, a lower panel, and a hinge coupling the upper panel and the lower panel such that the upper panel and the lower panel are allowed to be folded or unfolded, and in a state where the upper panel and the lower panel are unfolded, the hinge is positioned either parallel to a horizontal plane or tilted relative to the horizontal plane such that a front side of the hinge is tilted toward the lower panel.

A vehicle disclosed here is a vehicle including a windshield, and the windshield includes a body portion made of a transparent material, and a convex portion located in an intermediate portion of the body portion in a top-bottom direction, projecting forward from the body portion, and extending in a vehicle width direction, and the convex portion is positioned either parallel to a horizontal plane or tilted relative to the horizontal plane such that a front side of the convex portion is tilted downward.

A windshield disclosed here is a windshield that is attached to a vehicle, and includes: an upper panel; a lower panel; and a hinge coupling the upper panel and the lower panel to each other such that the upper panel and the lower panel are allowed to be folded or unfolded, wherein in a state where the upper panel and the lower panel are unfolded, the hinge is positioned such that a front side of the hinge is tilted toward the lower panel relative to a reference plane, the reference plane being parallel to a width direction of the lower panel and perpendicular to the lower panel.

### BRIEF DESCRIPTION OF THE DRAWINGS

FIG. 1 is a left side view of a utility vehicle according to an embodiment.

FIG. 2 is a front view of the utility vehicle.

FIG. 3 is a side view illustrating an upper panel and a lower panel in an unfolded state, as viewed in a vehicle width direction.

FIG. 4 is a side view illustrating the upper panel and the lower panel in a folded state, as viewed in the vehicle width direction.

FIG. 5 is a cross-sectional view of locks attached to the upper panel, as viewed from above.

FIG. 6 is a perspective view of a fastener attached to the left end of an upper portion of the lower panel, as viewed from the front.

FIG. 7 is a cross-sectional view of a fixer attached to the lower panel, as viewed from the left.

FIG. 8 is a cross-sectional view of a movement stopper attached to the lower panel, as viewed from the left.

FIG. 9 is a cross-sectional view of the movement stopper holding the folded upper panel, as viewed from the left.

FIG. 10 is a perspective view of a luminaire and a mount of a utility vehicle according to a first variation, as viewed from the front.

FIG. 11 is a perspective view of the luminaire and the mount, as viewed from the rear.

FIG. 12 is a side view of the luminaire and the mount, as viewed from the left.

FIG. 13 is a plan view of the luminaire and the mount, as viewed from above.

FIG. 14 is a front view of an upper front portion of a utility vehicle according to a second variation, as viewed from the front.

FIG. 15 is a cross-sectional view of the upper front portion of the utility vehicle according to the second variation, as seen from the left.

### DESCRIPTION OF EMBODIMENTS

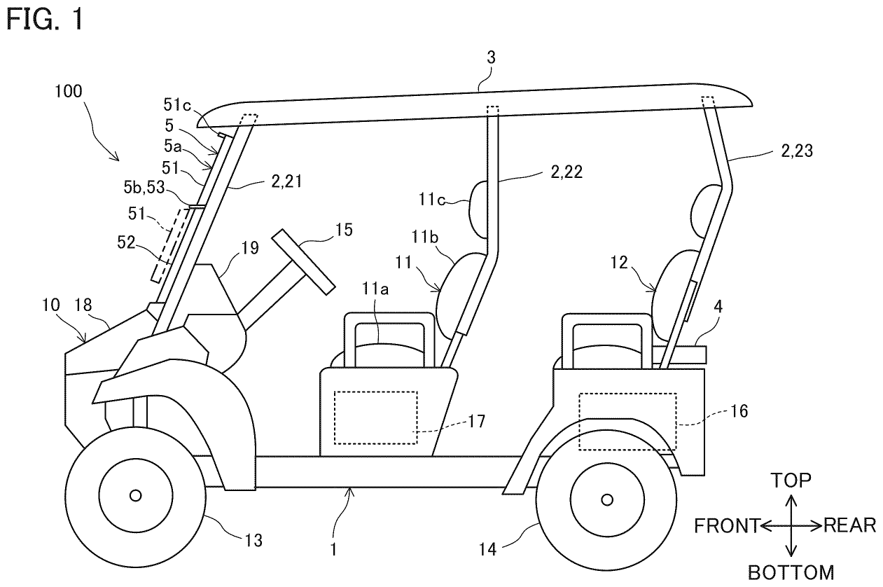

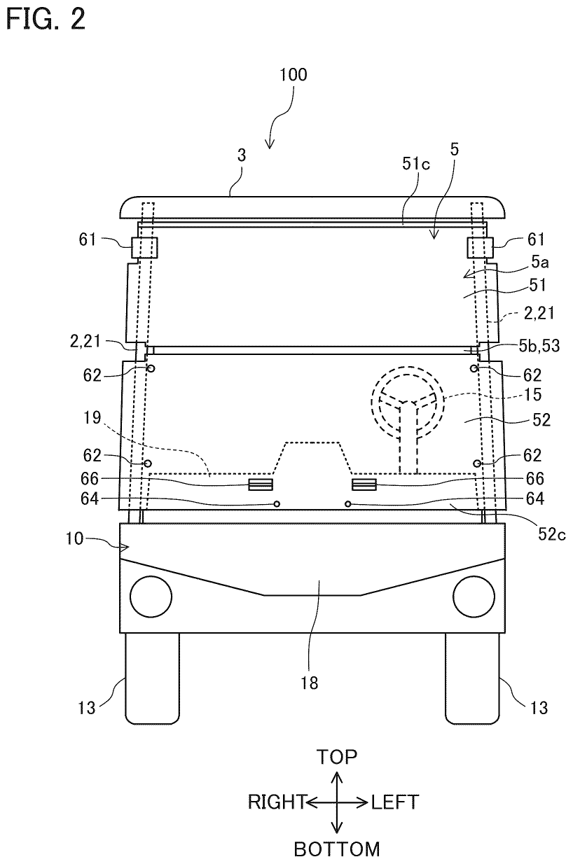

An exemplary embodiment will be described in detail hereinafter with reference to the drawings. FIG. 1 is a left side view of a utility vehicle 100. FIG. 2 is a front view of the utility vehicle 100. Hereinafter, the utility vehicle 100 will also be referred to simply as a “vehicle 100.”

The vehicle 100 corresponds to one example of a vehicle disclosed here. The vehicle 100 is a vehicle intended to travel at low speed in a limited area. Examples of the limited area include a limited community area, a private road, and a private property (e.g., a golf course, a park, etc.). The limited community area refers to an area available for use by local residents. The community area is, for example, an area including houses and public facilities (e.g., schools, hospitals, etc.), and is an area where the vehicle 100 not intended to travel on a public road is permitted to travel at low speed. The low speed refers to a speed up 20 mph to 30 mph, for example. The vehicle 100 may travel at a speed of 20 mph or less or 30 mph or more. The vehicle 100 includes, for example, a personal transport vehicle (PTV). The PTV includes a golf cart. The vehicle 100 may be other golf carts such as a low speed vehicle (LSV).

In this disclosure, components of the vehicle 100 will be described based on directions of the vehicle 100. Specifically, “front” refers to the front of the vehicle 100 in the vehicle front-rear directions, and “rear” refers to the rear of the vehicle 100 in the vehicle front-rear directions. “Left” refers to the left of the vehicle 100 when seeing forward, and “right” refers to the right of the vehicle 100 when seeing forward. The “vehicle width direction” refers to the vehicle width direction of the vehicle 100, in other words, means the left-right direction of the vehicle 100 and will be sometimes referred to as a “left-right direction.” An “inner side in the vehicle width direction” refers to a cabin side in the vehicle width direction, and an “outer side in the vehicle width direction” refers to a vehicle outer side in the vehicle width direction. The expression “a member extends or expands in a direction” herein includes not only a case where the member extends or expands strictly in parallel with the direction” but also a case where the member extends or expands generally in the direction.”

The vehicle 100 includes a windshield 5. The windshield 5 is attached to a front portion of the vehicle 100. The windshield 5 is located forward of a cabin of the vehicle 100. The windshield 5 is a front windshield. The windshield 5 can be opened and closed. Specifically, an upper portion (upper panel 51) of the windshield 5 is folded forward as indicated by the solid line to the chain double-dashed line in FIG. 1, and thereby, the windshield 5 changes from a closed state to an open state. In the closed state of the windshield 5, entry of rain and wind into the cabin is prevented. In the open state of the windshield 5, outside air can be taken into the cabin. In FIG. 1, the open state of the windshield 5 is indicated by the chain double-dashed line.

The vehicle 100 further includes a body frame 1, pillars 2 attached to the body frame 1 and extending in the top-bottom direction, and a roof 3 supported by the pillars 2.

The body frame 1 is a portion serving as a framework of a lower portion of the vehicle 100. The body frame 1 is constituted by combining metal pipe parts, metal plate parts, or casted parts, for example. The body frame 1 includes longitudinal frames extending in the front-rear direction and arranged in the vehicle width direction, and lateral frames extending in the vehicle width direction and arranged in the front-rear direction.

The pillars 2 include front pillars 21, center pillars 22, and rear pillars 23. The front pillars 21 will also be referred to as A pillars, the center pillars 22 will also be referred to as B pillars, and the rear pillars 23 will also be referred to as C pillars. When the front pillars 21, the center pillars 22, and the rear pillars 23 are not distinguished from one another, these pillars are referred to simply as “pillars 2.”

Lower portions of the pillars 2 are supported by the body frame 1, and upper portions of the pillars 2 support the roof 3. The pillars 2 are hollow cylinders. A cross section of each of the pillars 2 in a direction orthogonal to the axis thereof is circular. The pillars 2 may be made of a metal or a resin.

The front pillars 21, the center pillars 22, and the rear pillars 23 are arranged in this order from the front toward the rear. The front pillars 21 are individually disposed at the left and right in the vehicle width direction. Similarly, the center pillars 22 are individually disposed at the left and right in the vehicle width direction, and the rear pillars 23 are individually disposed at the left and right in the vehicle width direction. The front pillars 21 and the center pillars 22 define a front cabin part. The center pillars 22 and the rear pillars 23 define a rear cabin part.

The roof 3 is supported by the front pillars 21, the center pillars 22, and the rear pillars 23. The roof 3 expands in the front-rear direction and the left-right direction to cover the cabin from above. In the vehicle width direction, the roof 3 extends from the outer side of the left front pillar 21 to the outer side of the right front pillar 21. The roof 3 extends from the outer side of the front pillars 21 to the outer side of the rear pillars 23 in terms of the front-rear direction.

The vehicle 100 further includes front seats 11 and rear seats 12. The front seats 11 and the rear seats 12 are supported by the body frame 1. The front seats 11 are individually located at the left and right in the vehicle width direction, and the rear seats 12 are also individually located at the left and right in the vehicle width direction. The front seats 11 are located forward of the rear seats 12. The front seats 11 are located in the front cabin part. The rear seats 12 are located in the rear cabin part. Each of the front seats 11 includes a seat surface 11a, a seat back 11b, and a headrest 11c. Similar to the configuration of the front seats 11, each of the rear seats 12 includes a seat surface, a seat back, and a headrest. The headrest 11c may be omitted.

The vehicle 100 further includes front wheels 13 and rear wheels 14. The front wheels 13 support a front portion of the body frame 1. The rear wheels 14 support a rear portion of the body frame 1. The front wheels 13 are individually located at the left and right in the vehicle width direction, and the rear wheels 14 are individually located at the left and right in the vehicle width direction. That is, the vehicle 100 is a four-wheeled vehicle.

The vehicle 100 further includes a body panel 10. The body panel 10 covers parts supported by the body frame 1. The body panel 10 defines an appearance of the vehicle 100. The body panel 10 includes a hood 18 and a dashboard 19.

The hood 18 is attached to a front portion of the body frame 1. The hood 18 is located outside the vehicle The hood 18 corresponds to a top cover of a front portion of the vehicle 100.

The dashboard 19 is attached to the body frame 1 behind the hood 18. The dashboard 19 is located mainly in the cabin. The dashboard 19 faces the front seats 11. The dashboard 19 includes a drink holder, a speedometer, and a glove box.

A steering wheel 15 is located behind the dashboard 19. A driver operates the steering wheel 15 to thereby change the angle of the front wheels 13 to the axle and change the traveling direction of the vehicle 100.

The vehicle 100 further includes a cargo bed 4 located in a rear portion of the vehicle 100. The cargo bed 4 is located behind the rear seats 12. The cargo bed 4 extends in the vehicle width direction.

The vehicle 100 further includes a motor 16 and a battery 17. The motor 16 is an electric motor that converts electric energy to rotation movement for traveling. The battery 17 stores electric energy and supplies the electric energy to the motor 16. The motor 16 is located under the rear seats 12. The battery 17 is located under the front seats 11. The motor 16 may be an internal combustion engine, and in this case, the vehicle 100 includes a fuel tank.

The windshield 5 includes a body portion 5a and a convex portion 5b. The body portion 5a is made of a transparent material. The convex portion 5b is located in an intermediate part of the body portion 5a in the top-bottom direction, projects forward from the body portion 5a, and extends in the vehicle width direction. The body portion 5a includes an upper panel 51 and a lower panel 52. The convex portion 5b includes a hinge 53 coupling the upper panel 51 and the lower panel 52 to each other.

Each of the upper panel 51 and the lower panel 52 is made of, for example, a resin such as polycarbonate. The hinge 53 is made of, for example, an elastic material such as rubber or a resin.

In the closed state of the windshield 5, the upper panel 51 is located above the lower panel 52. The upper panel 51 and the lower panel 52 extend in the vehicle width direction and the top-bottom direction and cover the front of the cabin. In the vehicle width direction, the upper panel 51 and the lower panel 52 extend from the outer side of the left front pillar 21 to the outer side of the right front pillar 21. The upper panel 51 extends from intermediate portions to upper portions of the front pillars 21 in terms of the top-bottom direction. The lower panel 52 extends from intermediate portions to lower portions of the front pillars 21 in terms of the top-bottom direction.

The upper panel 51 is detachably fixed to the pillars 2. Specifically, the vehicle 100 includes locks 61. The locks 61 detachably lock the upper panel 51 to the front pillars 21. The locks 61 are individually located on the left and right ends of an upper portion of the upper panel 51.

The lower panel 52 is fixed to the pillars 2. Specifically, the vehicle 100 includes fasteners 62. The fasteners 62 fasten the lower panel 52 to the front pillars 21. The fasteners 62 are individually located on the left and right ends of an upper portion of the lower panel 52, and are individually located on the left and right ends of a lower portion of the lower panel 52.

The lower panel 52 is fixed to the body panel 10. Specifically, the vehicle 100 includes fixers 64. The fixers 64 fix a lower end portion 52c of the lower panel 52 to the dashboard 19 of the body panel 10. Two fixers 64 are located on a center portion of the lower end portion 52c of the lower panel 52. The two fixers 64 are arranged side by side in the vehicle width direction.

Movement stoppers 66 are attached to the lower panel 52. The movement stoppers 66 hold a folded state of the upper panel 51. That is, the movement stoppers 66 hold the open state of the windshield 5. Two movement stoppers 66 are located on a center portion of a lower portion of the lower panel 52. The two movement stoppers 66 are arranged side by side in the vehicle width direction. The movement stoppers 66 are located above the fixers 64.

The hinge 53 is located between the upper panel 51 and the lower panel 52. The hinge 53 extends from the inner side of the left front pillar 21 to the inner side of the right front pillar 21 in the vehicle width direction. The hinge 53 is located below the upper end of the headrest 11c in terms of the top-bottom direction. In a case where the headrest 11c is omitted, the hinge 53 may be located below a member located on a head portion of the driver in terms of the top-bottom direction. For example, as long as the seat back 11b extends to the head portion and supports the head of the driver, the hinge 53 only needs to be located below the upper end of the seatback 11b.

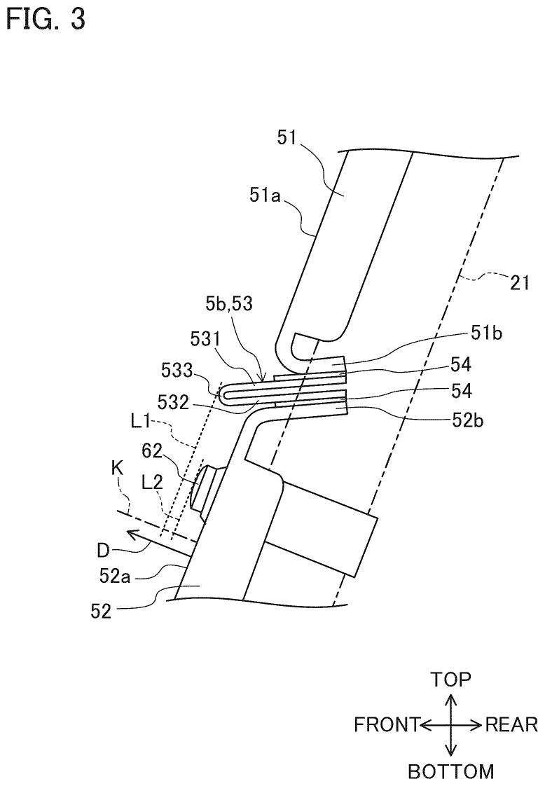

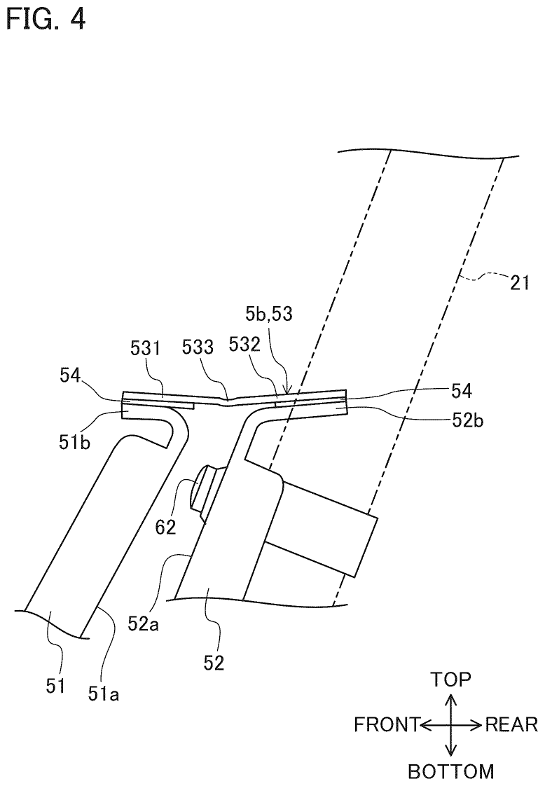

The hinge 53 couples the upper panel 51 and the lower panel 52 to each other such that the upper panel 51 and the lower panel 52 are allowed to be folded or unfolded. FIG. 3 is a side view of the upper panel 51 and the lower panel 52 in an unfolded state, as viewed in the vehicle width direction. FIG. 4 is a side view of the upper panel 51 and the lower panel 52 in a folded state, as viewed in the vehicle width direction.

The unfolded state of the upper panel 51 and the lower panel 52 refers to the closed state of the windshield 5, and in this state, a front surface 51a of the upper panel 51 and a front surface 52a of the lower panel 52 expand in the same plane, for example. The folded state of the upper panel 51 and the lower panel 52 refers to the open state of the windshield 5, and the front surface 51a of the upper panel 51 and the front surface 52a of the lower panel 52 face each other, for example.

In the windshield 5, in the state where upper panel 51 and the lower panel 52 are unfolded, the hinge 53 is positioned such that the front side of the hinge 53 is tilted toward the lower panel 52 relative to a plane parallel to a reference plane K that is parallel to the width direction of the lower panel 52 and perpendicular to the lower panel 52.

In the vehicle 100, in the state where the upper panel 51 and the lower panel 52 are unfolded, the hinge 53 is positioned either parallel to the horizontal plane or tilted relative to the horizontal plane such that the front side of the hinge 53 is tilted toward the lower panel 52. In other words, the convex portion 5b is positioned either parallel to the horizontal plane or tilted relative to the horizontal plane such that the front side of the convex portion 5b is tilted downward. In this example, the hinge 53 is parallel to the horizontal plane.

The hinge 53 couples the upper panel 51 and the lower panel 52 to each other such that the upper panel 51 and the lower panel 52 are folded by laying the upper panel 51 forward relative to the lower panel 52 or the upper panel 51 and the lower panel 52 are unfolded by raising the upper panel 51 rearward relative to the lower panel 52.

Specifically, the hinge 53 includes a first flat plate portion 531 connected to the upper panel 51, a second flat plate portion 532 connected to the lower panel 52, and a coupling portion 533 coupling the first flat plate portion 531 and the second flat plate portion 532 to each other such that the first flat plate portion 531 and the second flat plate portion 532 are allowed to be folded or unfolded. In a state where the upper panel 51 and the lower panel 52 are unfolded, the coupling portion 533 is bent, and the first flat plate portion 531 and the second flat plate portion 532 are folded. That is, in the state where the upper panel 51 and the lower panel 52 are unfolded, the hinge 53 has a U shape.

The first flat plate portion 531 is fixed to an edge portion 51b of the upper panel 51 with an adhesive 54. The second flat plate portion 532 is fixed to an edge portion 52b of the lower panel 52 with the adhesive 54. In the state where the upper panel 51 and the lower panel 52 are unfolded, the first flat plate portion 531 and the second flat plate portion 532 expand in the front-rear direction and the vehicle width direction, and the coupling portion 533 is connected to a front end portion of the first flat plate portion 531 and a front end portion of the second flat plate portion 532.

A front portion of the hinge 53 serves as a fulcrum of folding or unfolding of the upper panel 51 and the lower panel 52. Specifically, the front portion of the hinge 53 includes the coupling portion 533, and the coupling portion 533 includes the fulcrum. In the state where the upper panel 51 is unfolded relative to the lower panel 52, the front end of the front portion of the hinge 53 is located forward of the front surface 52a of the lower panel 52 in terms of a direction D perpendicular to the front surface 52a of the lower panel 52. Specifically, a position L1 of the front end of the front portion of the hinge 53 is located forward of the front surface 52a of the lower panel 52 in terms of the perpendicular direction D. The position L1 is parallel to the front surface 52a of the lower panel 52.

In the state where the upper panel 51 is unfolded relative to the lower panel 52, the front end of the front portion of the hinge 53 is located forward of the fasteners 62 in terms of the direction D perpendicular to the front surface 52a of the lower panel 52. Specifically, the position L1 of the front end of the front portion of the hinge 53 is located forward of a position L2 of the front ends of the fasteners 62 in terms of the perpendicular direction D. The position L2 is parallel to the front surface 52a of the lower panel 52.

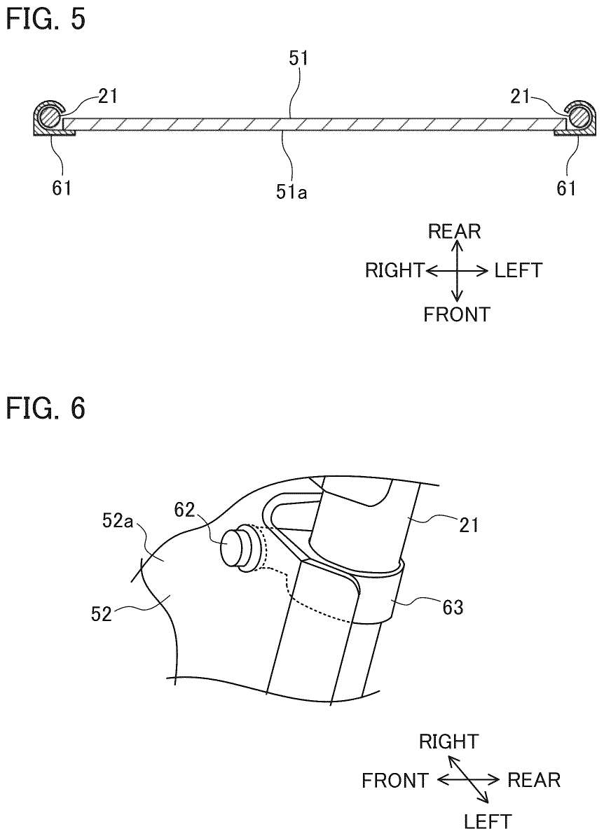

FIG. 5 is a cross-sectional view of the locks 61 attached to the upper panel 51, as viewed from above. The locks 61 has a C-shaped cross section. First ends of the locks 61 are fixed to the front surface 51a of the upper panel 51. The front pillars 21 are inserted into the radially inner holes of the locks 61 so that the locks 61 are locked to the front pillars 21. The locks 61 are made of an elastic material such as ethylene propylene rubber. The locks 61 are elastically deformed to extend second ends of the locks 61 and to be detached from the front pillars 21.

FIG. 6 is a perspective view of the fastener 62 attached to the left end of an upper portion of the lower panel 52, as viewed from the front. The fastener 62 penetrates the lower panel 52 to be fastened to a ring 63 attached to the front pillar 21. Accordingly, the fastener 62 and the ring 63 sandwich and support the lower panel 52. The fastener 62 is, for example, a bolt. The front pillar 21 is inserted into the radially inner hole of the ring 63, and the ring 63 is attached to the front pillar 21. The ring 63 includes a screw hole in which the fastener 62 is fastened. Although FIG. 6 shows the fastener 62 and the ring 63 attached to the left end of an upper portion of the lower panel 52, the other fasteners 62 and rings 63 have the same structure.

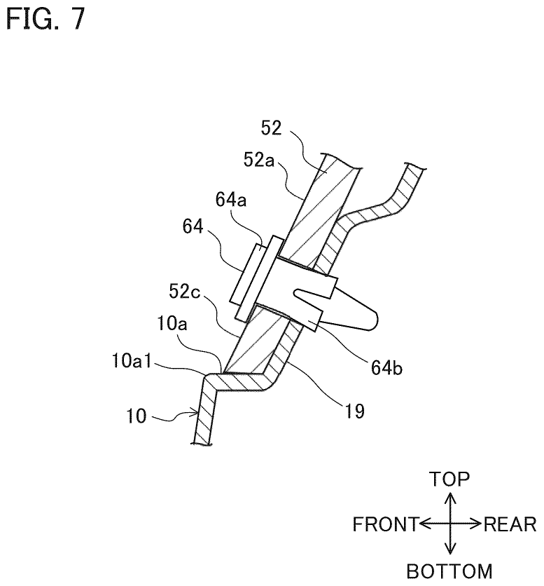

FIG. 7 is a cross-sectional view of the fixer 64 attached to the lower panel 52, as viewed from the left. The fixer 64 penetrates the lower panel 52 and are fixed to the dashboard 19 of the body panel 10. Accordingly, the fixer 64 and the dashboard 19 sandwich and support the lower panel 52. The fixer 64 is, for example, a rivet. In this example, the fixer 64 is a push rivet. The fixer 64 may be other fixing members that can be attached without a tool, as well as the rivet. For example, the fixer 64 may be a screw that can be attached by hand. Accordingly, the lower panel 52 can be easily attached and detached to/from the body panel 10.

Each fixer 64 includes a pin 64a and a socket 64b. The pin 64a is inserted into the socket 64b. The head of the pin 64a is located forward of the front surface 52a of the lower panel 52, and the socket 64b is inserted into a hole of the dashboard 19. When the head of the pin 64a is pushed, the tip of the pin 64a expands legs of the socket 64b from the inner side of the socket 64b. When the legs of the socket 64b expand, the socket 64b is thereby fixed to the hole of the dashboard 19. Accordingly, the fixer 64 is fixed to the dashboard 19.

The body panel 10 includes a step 10a supporting the lower end portion 52c of the lower panel 52. Specifically, the dashboard 19 includes the step 10a. The step 10a expands in parallel with the horizontal plane. A front end 10a1 of the step 10a is located forward of the lower panel 52 in terms of the front-rear direction. The front end 10a1 of the step 10a is located forward of the fixer 64 in terms of the front-rear direction.

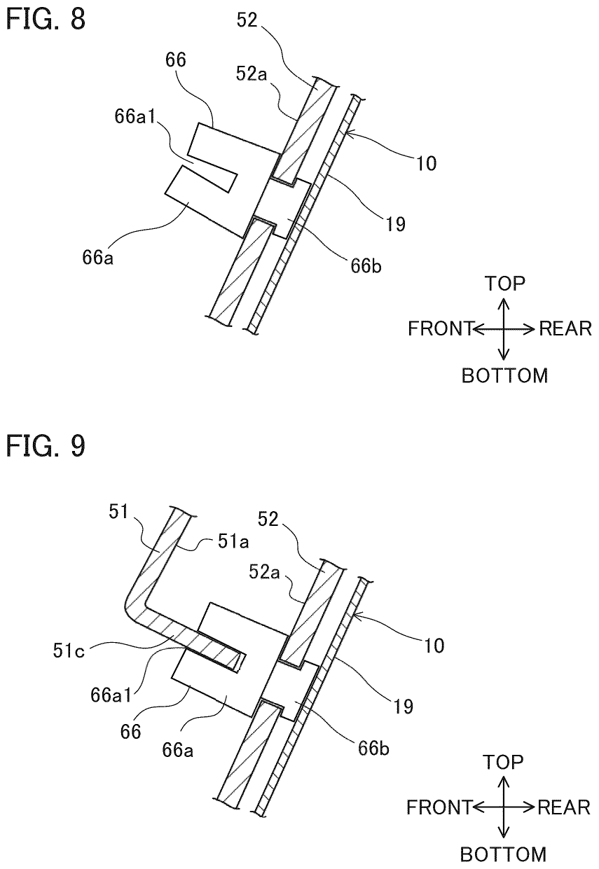

FIG. 8 is a cross-sectional view of the movement stopper 66 attached to the upper panel 52, as viewed from the left. The movement stopper 66 can be attached to the lower panel 52 while penetrating the lower panel 52. The movement stopper 66 includes a pinch 66a and a retainer 66b. The pinch 66a is located forward of the front surface 52a of the lower panel 52, and the retainer 66b is located between the lower panel 52 and the dashboard 19.

The pinch 66a includes a fitting groove 66a1 that is open forward and in the left-right direction. The retainer 66b is larger than the hole of the lower panel 52 the movement stopper 66 penetrates, and thus, prevents the movement stopper 66 from coming off forward from the lower panel 52.

The movement stopper 66 is made of, for example, an elastic material such as rubber. The retainer 66b is inserted into the hole of the lower panel 52 while being elastically deformed, passes through the hole of the lower panel 52, and then returns to the original shape so that the movement stopper 66 s locked to the lower panel 52.

FIG. 9 is a cross-sectional view of the movement stopper 66 holding the folded upper panel 51, as viewed from the left. In the state where the upper panel 51 is folded relative to the lower panel 52, the movement stopper 66 prevents the upper panel 51 to move relative to the lower panel 52.

Specifically, the upper panel 51 includes a projection 51c. As illustrated in FIG. 2, the projection 51c is located on an upper portion of the upper panel 51 and projects forward in the unfolded state of the upper panel 51. The projection 51c extends in the vehicle width direction.

In the folded state of the upper panel 51, the projection 51c of the upper panel 51 is fitted in the fitting groove 66a1 of the pinch 66a of the movement stopper 66. The pinch 66a holds the projection 51c while applying an elastic force to the projection 51c. On the other hand, to shift the upper panel 51 from the folded state to the unfolded state, a passenger pulls out the projection 51c from the fitting groove 66a1 and raises the upper panel 51 rearward.

In the vehicle 100 described above, since the hinge 53 is positioned either parallel to the horizontal plane or tilted relative to the horizontal plane such that the front side of the hinge 53 is tilted toward the lower panel 52, visibility of the passenger is enhanced, and entry of rainwater into the cabin is reduced.

Specifically, in the case where the hinge 53 is tilted relative to the horizontal plane such that the front side of the hinge 53 is tilted toward the upper panel 51, the blind spot of the passenger by the hinge 53 increases, and rainwater falling along the upper panel 51 flows into the cabin along the hinge 53. On the other hand, according to the present disclosure, since the hinge 53 is positioned either parallel to the horizontal plane or tilted relative to the horizontal plane such that the front side of the hinge 53 is tilted toward the lower panel 52, the blind spot of the passenger by the hinge 53 is reduced, and visibility is enhanced. In addition, rainwater falling along the upper panel 51 is less likely to flow into the cabin along the hinge 53.

Since the convex portion 5b is positioned either parallel to the horizontal plane or tilted relative to the horizontal plane such that the front side of the convex portion 5b is tilted downward, the blind spot of the passenger by the convex portion 5b is reduced, and visibility is enhanced. Further, rainwater falling along the body portion 5a is less likely to flow into the cabin along the convex portion 5b.

Since the hinge 53 is located below the upper end of the headrest 11c, the hinge 53 is positioned on the line of sight of the passenger. In this case, the effect of enhancing visibility of the passenger can be further enhanced.

Since the hinge 53 couples the upper panel 51 to the lower panel 52 such that the upper panel 51 can be folded or unfolded relative to the lower panel 52, the passenger can prevent entry of traveling wind into the cabin by unfolding the upper panel 51 relative to the lower panel 52, whereas the passenger can take traveling wind into the cabin by folding the upper panel 51 relative to the lower panel 52.

Since the vehicle 100 includes the movement stoppers 66, the folded upper panel 51 is fixed to the lower panel 52 through the movement stoppers 66 to thereby stably take traveling wind into the cabin.

In the state where the upper panel 51 is unfolded relative to the lower panel 52, the front end of the front portion of the hinge 53 is located forward of the front surface 52a of the lower panel 52 in terms of the direction D perpendicular to the front surface 52a of the lower panel 52. Thus, it is possible to suppress contact between the lower panel 52 and the upper panel 51 in the state where the upper panel 51 is folded relative to the lower panel 52.

In the state where the upper panel 51 is unfolded relative to the lower panel 52, the front end of the front portion of the hinge 53 is located forward of the fasteners 62 in terms of the direction D perpendicular to the front surface 52a of the lower panel 52. Thus, it is possible to suppress interference between the lower panel 52 and the fasteners 62 in the state where the upper panel 51 is folded relative to the lower panel 52.

Since the vehicle 100 includes the fixers 64 as well as the fasteners 62, vibrations of the lower panel 52 can be suppressed during traveling.

Since the body panel 10 includes the step 10a supporting the lower end portion 52c of the lower panel 52, the lower panel 52 can be fixed by the fixers 64 with the lower end portion 52c of the lower panel 52 supported by the step 10a, and thus, the lower panel 52 can be easily attached to the body panel 10.

Since the front end 10a1 of the step 10a is located forward of the lower panel 52 in terms of the front-rear direction, the step 10a can support the entire lower end portion 52c of the lower panel 52, and thus, the lower panel 52 can be easily attached to the body panel 10.

In the windshield 5 described above, the hinge 53 is tilted relative to the reference plane K such that the that the front side of the hinge 53 is tilted toward the lower pane 52. Thus, in attaching the windshield 5 to the vehicle 100, the blind spot of the passenger by the hinge 53 can be reduced so that visibility is thereby enhanced. In addition, rainwater falling along the upper panel 51 is less likely to flow into the cabin along the hinge 53.

In the state where the upper panel 51 and the lower panel 52 are unfolded, the coupling portion 533 is bent and the first flat plate portion 531 and the second flat plate portion 532 are folded. Thus, in the state where the upper panel 51 and the lower panel 52 are unfolded, the size of the hinge 53 can be reduced in terms of the length direction of the lower panel 52. The length direction of the lower panel 52 is a direction in which the upper panel 51 and the lower panel 52 are coupled to each other or a direction orthogonal to the vehicle width direction on a principal surface (i.e., front surface 52a) of the lower panel 52.

Accordingly, in attaching the windshield 5 to the vehicle 100, the size of the hinge 53 in the top-bottom direction can be reduced. As a result, the blind spot of the passenger by the hinge 53 can be further reduced so that visibility is thereby enhanced.

### First Variation

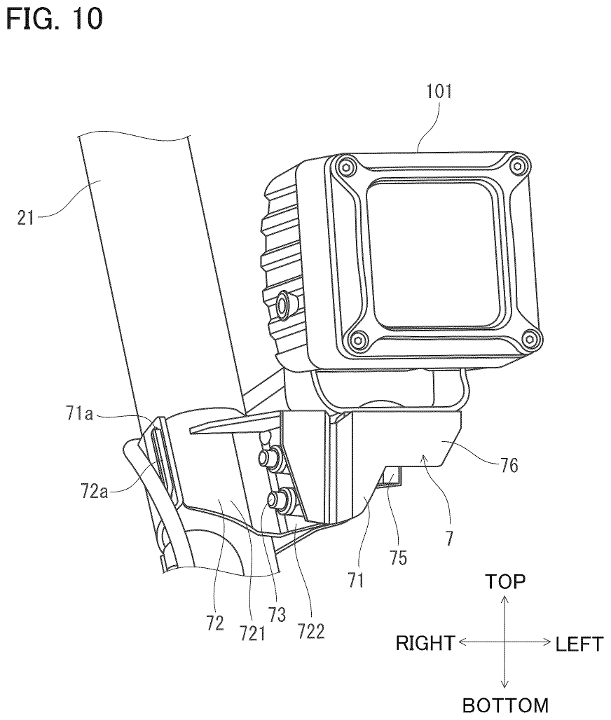

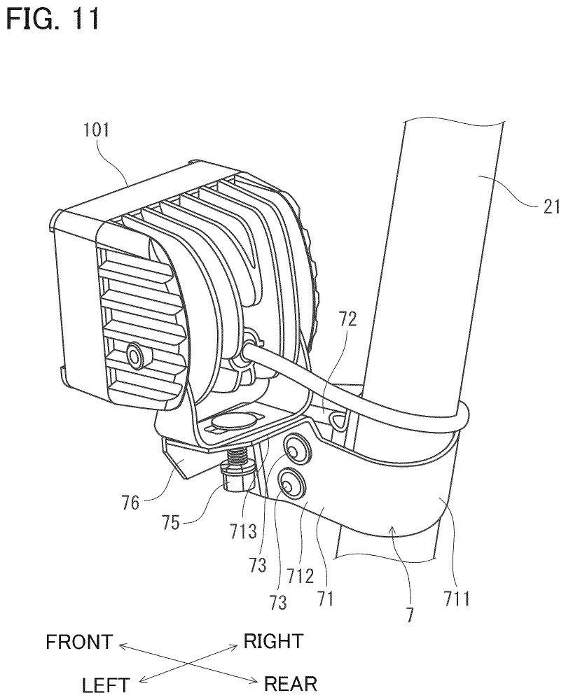

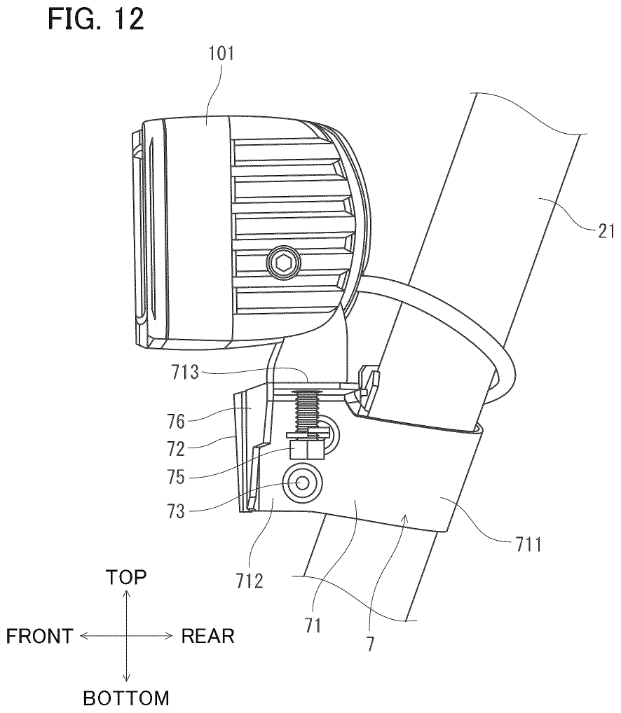

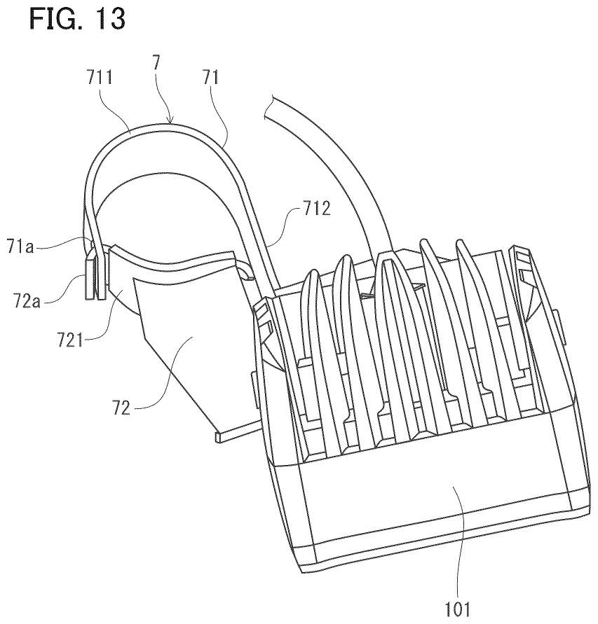

FIG. 10 is a perspective view of a luminaire 101 and a mount 7 of a vehicle (an example of a vehicle) according to a first variation, as viewed from the front. FIG. 11 is a perspective view of the luminaire 101 and the mount 7, as viewed from the rear. FIG. 12 is a side view of the luminaire 101 and the mount 7, as viewed from the left. FIG. 13 is a plan view of the luminaire 101 and the mount 7, as viewed from above. FIG. 13 does not show the pillars 21.

The vehicle according to the first variation is different from the vehicle 100 according to the embodiment in including the luminaire 101 and the mount 7. The following description will be directed mainly to a part of the configuration of the vehicle according to the first variation different from the vehicle 100 according to the embodiment. In the vehicle according to the first variation, the same reference characters as those of the vehicle 100 according to the embodiment denote the same components as those of the vehicle 100 according to the embodiment, and thus, description thereof will be omitted.

The vehicle according to the first variation further includes the luminaire 101 and the mount 7. The luminaire 101 is, for example, an LED light. The luminaire 101 is attached to pillars 2 to which a lower panel 52 is attached. Specifically, the luminaire 101 is attached to the front pillars 21 through the mount 7.

The mount 7 includes a first part 71 and a second part 72. The second part 72 and the first part 71 sandwich and support the pillar 2. The first part 71 includes a hole 71a. The second part 72 includes a nail 72a. The nail 72a is detachably locked to the hole 71a.

The first part 71 includes an arc portion 711 and an attachment portion 712. The hole 71a is located in a first end portion of the arc portion 711. The attachment portion 712 is connected to a second end portion of the arc portion 711. The second part 72 includes an arc portion 721 and an attachment portion 722. The nail 72a is located in a first end portion of the arc portion 721 The attachment portion 722 is connected to a second end of the arc portion 721.

The arc portion 711 and the arc portion 721 are fitted onto the outer circumference of the front pillar 21. The attachment portion 712 and the attachment portion 722 are overlapped and fastened by bolts 73. Accordingly, the first part 71 and the second part 72 sandwich the front pillars 21, and the mount 7 is attached to the front pillar 21.

The mount 7 includes a fastener 75 that fastens the luminaire 101 to the first part 71. The first part 71 further includes a shield 76 located forward of the fastener 75 and shielding at least a part of the fastener 75.

Specifically, the first part 71 includes a support 713 connected to an upper portion of the attachment portion 712. The support 713 expands in the front-rear direction and the left-right direction. The luminaire 101 is attached to the support 713 of the first part 71 through the fastener 75. The luminaire 101 is located above the support 713. The fastener 75 extends in the top-bottom direction. The fastener 75 is, for example, a bolt.

The shield 76 is connected to the attachment portion 712 and a front portion of the support 713. The shield 76 expands in the left-right direction and the top-bottom direction. The length of the shield 76 in the top-bottom direction is preferably greater than or equal to a half of the length, in the top-bottom direction, of a lower portion of the fastener 75 exposed from the support 713 to the outside.

In the vehicle according to the first variation, since the vehicle 100 includes the mount 7, the nail 72a of the second part 72 is locked to the hole 71a of the first part 71 so that the luminaire 101 can be thereby attached to the pillar 2 through the mount 7, and thus, the luminaire 101 can be easily attached to the pillar 2.

Since the mount 7 includes the shield 76, at least a part of the fastener 75 can be shielded by the shield 76 as seen from the front, and appearance is enhanced.

The description of other configurations, operations, and effects will be omitted, but the description of the vehicle 100 according to the embodiment can be used for the description of the vehicle according to the first variation.

### Second Variation

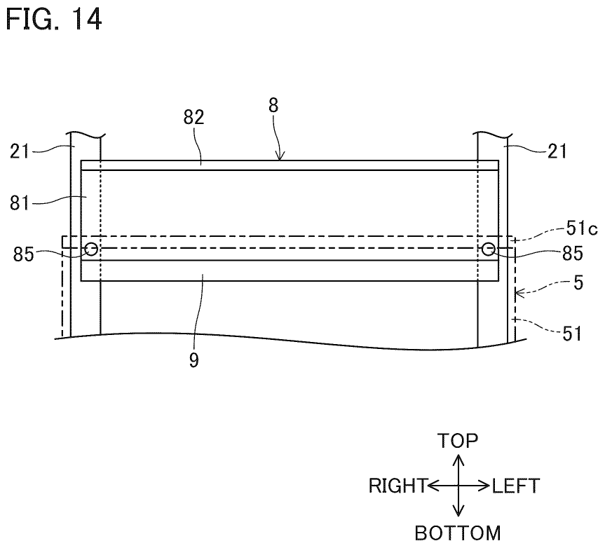

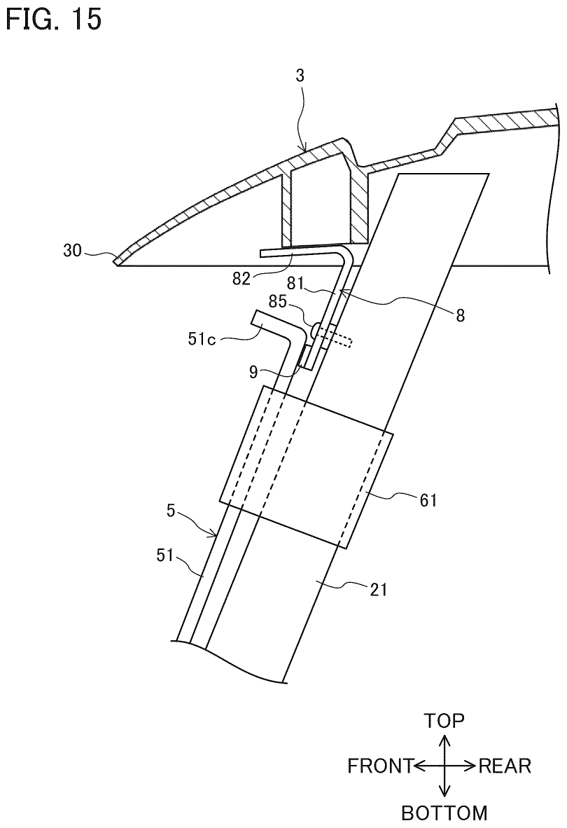

FIG. 14 is a front view of an upper front portion of a vehicle (an example of a vehicle) according to a second variation, as viewed from the front. FIG. 15 is a cross-sectional view of the upper front portion of the vehicle according to the second variation, as seen from the left. In FIG. 14, a windshield 5 is indicated by a chain double-dashed line, and a roof 3 is not shown.

The vehicle according to the second variation is different from the vehicle 100 according to the embodiment in including a plate 8 and an elastic member 9. The following description will be directed mainly to a part of the configuration of the vehicle according to the second variation different from the vehicle 100 according to the embodiment. In the vehicle according to the second variation, the same reference characters as those of the vehicle 100 according to the embodiment denote the same components as those of the vehicle 100 according to the embodiment, and thus, description thereof will be omitted.

The roof 3 is located above the windshield 5 with a space interposed therebetween. Specifically, in the unfolded state of the windshield 5, an upper portion (projection 51c) of the windshield 5 is located below the roof 3 with a space interposed therebetween. A front end portion 30 of the roof 3 is located forward of the upper portion of the windshield 5. Thus, the front end portion 30 of the roof 3 is located forward of the windshield 5 in a rotation direction in folding an upper panel 51. However, since the roof 3 is located above the windshield 5 with a space interposed therebetween, the windshield 5 does not interfere with the roof 3 during switching between folding and unfolding of the windshield 5.

The vehicle according to the second variation includes a plate 8. The plate 8 is located between the windshield 5 and the roof 3 in the top-bottom direction. Specifically, in the unfolded state of the windshield 5, the plate 8 is located between an upper portion of the windshield 5 and a lower portion of the roof 3.

The plate 8 is made of, for example, a resin such as polycarbonate. The plate 8 has light-shielding properties. Specifically, the plate 8 is a light-shielding member. For example, the plate body may contain a metal material such as iron or cobalt, or alternatively, a light-shielding film may be attached to the plate body.

The mount 8 includes a first part 81 and a second part 82. The second part 82 is connected to the first part 81.

The first part 81 expands in the top-bottom direction and the left-right direction. The first part 81 extends from a left front pillar 21 to a right front pillar 21 in the left-right direction. The first part 81 extends from the lower portion of the roof 3 to the upper portion of the windshield 5 in the top-bottom direction.

The first part 81 is inclined such that an upper portion of the first part 81 is located rearward and a lower portion of the first part 81 is located forward. The first part 81 is arranged along the front pillar 21.

The first part 81 is attached to the front pillars 21. Specifically, the first part 81 is fixed to the front pillars 21 through fasteners 85. The fasteners 85 are individually located on the left and right ends of the first part 81.

The second part 82 expands in the front-rear direction and the left-right direction. The second part 82 extends forward from the upper end of the first part 81. The second part 82 extends from the left front pillar 21 to the right front pillar 21 in the left-right direction.

The windshield 5 is located forward of the plate 8 and overlaps the plate 8. Specifically, in the unfolded state of the windshield 5, the upper portion of the windshield 5 located forward of the plate 8 and overlaps the lower portion of the plate 8. Specifically, the projection 51c of the windshield 5 located forward of the plate 8 and overlaps the lower portion 81 of the first part 8 of the plate 8. Accordingly, during switching between folding and unfolding of the windshield 5, the windshield 5 does not interfere with the plate 8.

The vehicle according to the second variation includes the elastic member 9. The elastic member 9 is located between the windshield 5 and the plate 9 in the front-rear direction. Specifically, in the unfolded state of the windshield 5, the elastic member 9 is located between the upper portion of the windshield 5 and the lower portion of the plate 8.

The elastic member 9 extends in the left-right direction. Specifically, the elastic member 9 extends across the entire left-right direction of the first part 81. The elastic member 9 may be located in a part of the left-right direction of the first part 81.

The elastic member 9 is attached to the plate 8. Specifically, the elastic member 9 is fixed to a lower portion of the first part 81 of the plate 8 through an adhesive or a tape.

The elastic member 9 is, for example, a rubber sponge. In the unfolded state of the windshield 5, the elastic member 9 is sandwiched and elastically deformed between the windshield 5 and the plate 8. Accordingly, the elastic member 9 is in close contact with the windshield 5 and the plate 8.

In the vehicle of variation 2, the plate 8 is located between the windshield 5 and the roof 3 in the top-bottom direction. Accordingly, the plate 8 closes the gap between the windshield 5 and the roof 3. This prevents rainwater and wind from entering the cabin from between the windshield 5 and the roof 3.

Specifically, if the gap between the windshield 5 and the roof 3 is not closed, rainwater and wind might enter the cabin from the gap. In contrast, according to the present disclosure, since the plate 8 is located over the gap between the windshield 5 and the roof 3, it is possible to prevent rain and wind from entering the cabin from between the windshield 5 and the roof 3.

The plate 8 has light-shielding properties. Accordingly, the plate 8 can also serve as a sun visor.

The elastic member 9 is located between the windshield 5 and the plate 8 in the front-rear direction. This prevents rainwater and wind from entering the cabin from between the windshield 5 and the plate 8.

The second part 82 extends forward from the upper end of the first part 81. This further prevents rainwater and wind from entering the cabin from between the plate 8 and the roof 3.

In the vehicle according to the second variation, the plate 8 has light-shielding properties, but may also have light-transmitting properties. The vehicle includes the elastic member 9, but may not include the elastic member 9.

The plate 8 includes the first part 81 and the second part 82, but may not include the second part 82. The second part 82 extends forward from the upper end of the first part 81, but may also extend rearward from the upper end of the first part 81. The first part 81 is attached to the front pillar 21, but the second part 82 may be attached to the roof 3.

The description of other configurations, operations, and effects will be omitted, but the description of the vehicle 100 according to the embodiment can be used for the description of the vehicle according to the second variation.

### Other Embodiments

In the foregoing section, the embodiment has been described as an example of the technique disclosed in the present application. The technique disclosed here, however, is not limited to this embodiment, and is applicable to other embodiments obtained by changes, replacements, additions, and/or omissions as necessary. Components described in the above embodiment may be combined as a new exemplary embodiment. Components provided in the accompanying drawings and the detailed description can include components unnecessary for solving problems as well as components necessary for solving problems in order to exemplify the technique. Therefore, it should not be concluded that such unnecessary components are necessary only because these unnecessary components are included in the accompanying drawings or the detailed description.

The vehicle 100 may be a single-passenger vehicle. The vehicle 100 may include only one seat or three or more seats in the front-rear direction. The vehicle 100 may also be a three-wheeled vehicle having three wheels, or may be a six-wheeled vehicle having six wheels.

The number of the hinge 53 can be increased or reduced. For example, the hinge 53 may be divided into parts in the vehicle width direction.

In the state where the upper panel 51 and the lower panel 52 are unfolded, the hinge 53 is positioned in parallel with the horizontal plane. Alternatively, the front side of the hinge 53 may be tilted relative to the horizontal plane such that the front side of the hinge 53 is tilted toward the lower panel 52.

Although the hinge 53 is located below the upper end of the headrest 11c in terms of the top-bottom direction, the hinge 53 may be located above the upper end of the headrest 11c.

Although the upper panel 51 moves to be folded or unfolded relative to the lower panel 52, the lower panel 52 may be moved to be folded or unfolded relative to the upper panel 51.

The vehicle 100 includes the movement stoppers 66, but may not include the movement stoppers 66.

In the state where the upper panel 51 is unfolded relative to the lower panel 52, the front end of the front portion of the hinge 53 is located forward of the surface 52a of the lower panel 52, but may be located rearward of the front surface 52a of the lower panel 52, in terms of the direction D perpendicular to the front surface 52a of the lower panel 52.

In the state where the upper panel 51 is unfolded relative to the lower panel 52, the front end of the front portion of the hinge 53 is located forward of the fasteners 62, but may be located rearward of the fasteners 62, in terms of the direction D perpendicular to the front surface 52a of the lower panel 52.

The vehicle 100 includes the fasteners 62 and the fixers 64, but may include any one of the fasteners 62 or the fixers 64.

Although the body panel 10 includes the step 10a, but may not include the step 10a.

The front end 10a1 of the step 10a is located forward of the lower panel 52, but may be located rearward of the lower panel 52, in terms of the front-rear direction.

The vehicle 100 includes the mount 7, but may not include the mount 7.

In the mount 7, although the first part 71 includes the hole 71a and the second part 72 includes the nail 72a, the first part 71 may include a nail and the second part 72 may include a hole.

The luminaire 101 may be fastened to the first part 71 by the fastener 75, but may be fastened to the second part 72 by the fastener 75. In this case, the second part 72 includes the shield 76.

Although the upper panel 51 and the lower panel 52 are coupled to each other by the hinge 53 to be allowed to be folded or unfolded, but the upper panel 51 and the lower panel 52 may be movable upward and downward relative to each other. In this case, the body portion 5a does not correspond to a door that can be folded or unfolded but corresponds to a slide door, and the convex portion 5b does not correspond to a hinge but correspond to a grip portion that lifts and lowers a slide door.

The vehicle of the present disclosure may be an off-road vehicle or an on-road vehicle. Examples of the off-road vehicle include a utility vehicle, a side-by-side vehicle, and a tractor.

### Aspects

The embodiments described above are specific examples of the following aspects.

### Aspect 1

A vehicle (utility vehicle 100) is a vehicle including a windshield 5. The windshield 5 includes an upper panel 51, a lower panel 52, and a hinge 53 coupling the upper panel 51 and the lower panel 52 to each other such that the upper panel 51 and the lower panel 52 are allowed to be folded or unfolded, and in a state where the upper panel 51 and the lower panel 52 are unfolded, the hinge 53 is positioned either parallel to a horizontal plane or tilted relative to the horizontal plane such that a front side of the hinge 53 is tilted toward the lower panel 52.

This configuration can reduce the blind spot of a passenger by the hinge 53 so that visibility is thereby enhanced.

### Aspect 2

In the vehicle of Aspect 1,
the hinge 53 is located below an upper end of a headrest 11c in terms of a top-bottom direction.

In this case, the hinge 53 is positioned on the line of sight of the passenger, and in this case, the effect of enhancing visibility of the passenger can be further enhanced.

### Aspect 3

In the vehicle of Aspect 1 or Aspect 2, the upper panel 51 is detachably fixed to a pillar 2, and
the hinge 53 couples the upper panel 51 and the lower panel 52 to each other such that the upper panel 51 and the lower panel 52 are folded by laying the upper panel 51 forward relative to the lower panel 52 or the upper panel 51 and the lower panel 52 are unfolded by raising the upper panel 51 rearward relative to the lower panel 52.

In this configuration, the passenger can prevent traveling wind from entering the cabin by unfolding the upper panel 51 relative to the lower panel 52, whereas the passenger can take traveling wind into the cabin by folding the upper panel 51 relative to the lower panel 52.

### Aspect 4

The vehicle of any one of Aspects 1 to 3 further includes:
a movement stopper 66 that prevents the upper panel 51 from moving relative to the lower panel 52 in a state where the upper panel 51 is folded relative to the lower panel 52.

In this configuration, the folded upper panel 51 is fixed to the lower panel 52 so that traveling wind can be thereby stably taken into the cabin.

### Aspect 5

In the vehicle of any one of Aspects 1 to 4,
a front portion of the hinge 53 serves as a fulcrum in folding or unfolding the upper panel 51 and the lower panel 52, and in a state where the upper panel 51 is unfolded relative to the lower panel 52, a front end of the front portion of the hinge 53 is located forward of a front surface 52a of the lower panel 52 in terms of a direction perpendicular to the front surface 52a of the lower panel 52.

In this configuration, in the state where the upper panel 51 is folded relative to the lower panel 52, contact between the lower panel 52 and the upper panel 51 can be suppressed.

### Aspect 6

In the vehicle of any one of Aspects 1 to 5, further includes
the fastener 62 that fastens the lower panel 52 to a pillar 2, and
in a state where the upper panel 51 is unfolded relative to the lower panel 52, the front end of the front portion of the hinge 53 is located forward of the fastener 62 in terms of the direction perpendicular to the front surface 52a of the lower panel 52.

In this configuration, in the state where the upper panel 51 is folded relative to the lower panel 52, interference between the lower panel 52 and the fastener 62 can be suppressed.

### Aspect 7

The vehicle of any one of Aspects 1 to 6 further includes:
a fastener 62 that fastens the lower panel 52 to a pillar 2; and
a fixer 64 that fixes a lower end portion 52c of the lower panel 52 to a body panel 10.

This configuration can suppress vibrations of the lower panel 52 during traveling.

### Aspect 8

The vehicle of any one of Aspects 1 to 7,
the body panel 10 includes a step 10a supporting the lower end portion 52c of the lower panel 52.

In this configuration, in the state where the lower end portion 52c of the lower panel 52 is supported on the step 10a, the lower panel 52 can be fixed by the fixer 64 so that the lower panel 52 can be thereby easily attached to the body panel 10.

### Aspect 9

In the vehicle of any one of Aspects 1 to 8,
a front end 10a1 of the step 10a is located forward of the lower panel 52 in terms of a front-rear direction.

In this configuration, the step 10a can support the entire lower end portion 52c of the lower panel 52 so that the lower panel 52 can be thereby easily attached to the body panel 10.

### Aspect 10

In the vehicle of any one of Aspects 1 to 9, further includes
a mount 7 that attaches a luminaire 101 to a pillar 2 to which the lower panel 52 is attached,
the mount 7 includes a first part 71 and a second part 72, and the first part 71 and the second part sandwich and support the pillar 2,
the first part 71 includes a hole 71a, and
the second part 72 includes a nail 72a detachably locked to the hole 71a.

In this configuration, the nail 72a of the second part 72 is locked to the hole 71a of the first part 71 so that the luminaire 101 can be thereby attached to the pillar 2, and the luminaire 101 can be easily attached to the pillar 2.

### Aspect 11

In the vehicle of any one of Aspects 1 to 10,
the mount 7 includes a fastener 75 that fastens the luminaire 101 to one of the first part 71 or the second part 72, and
the one of the first part or the second part further includes a shield 76 that is located forward of the fastener 75 and shields at least a portion of the fastener 75.

In this configuration, at least a portion of fastener 75 can be shielded by the shield 76 as seen from the front, and thus, appearance can be enhanced.

### Aspect 12

The vehicle of any one of Aspects 1 to 11 further includes:
a roof 3 located above the windshield 5 with a space interposed therebetween; and
a plate 8 located between the windshield 5 and the roof 3 in a top-bottom direction.

This configuration prevents rainwater and wind from entering the cabin from between the windshield 5 and the roof 3.

### Aspect 13

In the vehicle of Aspect 12, the plate 8 has light-shielding properties.

With this configuration, the plate 8 can also serve as a sun visor.

### Aspect 14

In the vehicle of Aspect 12,
the windshield 5 located forward of the plate 8 and overlaps the plate 8 in a front-rear direction, and
the vehicle includes an elastic member 9 between the windshield 5 and the plate 8 in a front-rear direction.

This configuration prevents rainwater and wind from entering the cabin from between the windshield 5 and the plate 8.

### Aspect 15

A vehicle is a vehicle width direction including a windshield 5, and the windshield 5 includes: a body portion 5a made of a transparent material; and a convex portion 5b located in an intermediate portion of the body portion 5a in a top-bottom direction, projecting forward from the body portion 5a, and extending in a vehicle width direction, and the convex portion 5b is positioned either parallel to a horizontal plane or tilted relative to the horizontal plane such that a front side of the convex portion 5b is tilted downward.

This configuration can reduce the blind spot of a passenger by the convex portion 5b so that visibility is thereby enhanced.

### Aspect 16

A windshield 5 is a windshield 5 that is attached to a vehicle, and includes: an upper panel 51, a lower panel 52, and a hinge 53 coupling the upper panel 51 and the lower panel 52 to each other such that the upper panel 51 and the lower panel 52 are allowed to be folded or unfolded, in a state where the upper panel 51 and the lower panel 52 are unfolded, the hinge 53 is positioned such that a front side of the hinge 53 is tilted toward the lower panel 52 relative to a reference plane K, the reference plane K being parallel to a width direction of the lower panel 52 and perpendicular to the lower panel 52.

In this configuration, in attaching the windshield 5 to the vehicle, the blind spot of the passenger by the hinge 53 can be reduced, and thus, visibility is enhanced.

### Aspect 17

### The windshield 5 of Aspect 16,

the hinge 53 includes a first flat plate portion 531 connected to the upper panel 51, a second flat plate portion 532 connected to the lower panel 52, and a coupling portion 533 coupling the first flat plate portion 531 and the second flat plate portion 532 to each other such that the first flat plate portion 531 and the second flat plate portion 532 are allowed to be folded or unfolded, and
in a case where the upper panel 51 and the lower panel 52 are unfolded, the coupling portion 533 is bent, and the first flat plate portion 531 and the second flat plate portion 532 are folded.

In this configuration, in the state where upper panel 51 and the lower panel 52 are unfolded, the size of the hinge 5 can be reduced in terms of the length direction of the lower panel 52. This further reduces the blind spot of the passenger by the hinge 53, and thus, visibility can be enhanced.

What is claimed:

1. A vehicle comprising a windshield, wherein
the windshield includes
an upper panel,
a lower panel, and
a hinge coupling the upper panel and the lower panel such that the upper panel and the lower panel are allowed to be folded or unfolded, and
in a state where the upper panel and the lower panel are unfolded, the hinge is positioned either parallel to a horizontal plane or tilted relative to the horizontal plane such that a front side of the hinge is tilted toward the lower panel.

2. The vehicle according to claim 1, wherein
the hinge is located below an upper end of a headrest in terms of a top-bottom direction.

3. The vehicle according to claim 1, wherein
the upper panel is detachably fixed to a pillar, and
the hinge couples the upper panel and the lower panel to each other such that the upper panel and the lower panel are folded by laying the upper panel forward relative to the lower panel or the upper panel and the lower panel are unfolded by raising the upper panel rearward relative to the lower panel.

4. The vehicle according to claim 3, further comprising
a movement stopper that prevents the upper panel from moving relative to the lower panel in a state where the upper panel is folded relative to the lower panel.

5. The vehicle according to claim 3, wherein
a front portion of the hinge serves as a fulcrum in folding or unfolding of the upper panel and the lower panel, and in a state where the upper panel is unfolded relative to the lower panel, a front end of the front portion of the hinge is located forward of a front surface of the lower panel in terms of a direction perpendicular to the front surface of the lower panel.

6. The vehicle according to claim 5, further comprising
a fastener that fastens the lower panel to a pillar, wherein in the state where the upper panel is unfolded relative to the lower panel, the front end of the front portion of the hinge is located forward of the fastener in terms of the direction perpendicular to the front surface of the lower panel.

7. The vehicle according to claim 1, further comprising:
a fastener that fastens the lower panel to a pillar; and
a fixer that fixes a lower end portion of the lower panel to a body panel.

8. The vehicle according to claim 7, wherein the body panel includes a step supporting the lower end portion of the lower panel.

9. The vehicle according to claim 8, wherein
a front end of the step is located forward of the lower panel in terms of a front-rear direction.

10. The vehicle according to claim 1, further comprising
a mount that attaches a luminaire to a pillar to which the lower panel is attached, wherein
the mount includes a first part and a second part, the first part and the second part sandwich and support the pillar,
the first part includes a hole, and
the second part includes a nail that is detachably locked to the hole.

11. The vehicle according to claim 10, wherein
the mount includes a fastener that fastens the luminaire to one of the first part or the second part, and
the one of the first part or the second part further includes a shield that is located forward of the fastener and shields at least a portion of the fastener.

12. The vehicle according to claim 1, further comprising:
a roof located above the windshield with a space interposed therebetween; and
a plate located between the windshield vehicle and the roof in a top-bottom direction.

13. The vehicle according to claim 11, wherein the plate has light-shielding properties.

14. The vehicle according to claim 11, wherein
the windshield located forward of the plate and overlaps the plate in a front-rear direction, and
the vehicle comprises an elastic member between the windshield vehicle and the plate in a front-rear direction.

15. A vehicle comprising a windshield, wherein
the windshield includes
a body portion made of a transparent material, and
a convex portion located in an intermediate portion of the body portion in a top-bottom direction, projecting forward from the body portion, and extending in a vehicle width direction, and
the convex portion is positioned either parallel to a horizontal plane or tilted relative to the horizontal plane such that a front side of the convex portion is tilted downward.

16. A windshield that is attached to a vehicle, the windshield comprising:
an upper panel;
a lower panel; and
a hinge coupling the upper panel and the lower panel to each other such that the upper panel and the lower panel are allowed to be folded or unfolded, wherein in a state where the upper panel and the lower panel are unfolded, the hinge is positioned such that a front side of the hinge is tilted toward the lower panel relative to a reference plane, the reference plane being parallel to a width direction of the lower panel and perpendicular to the lower panel.

17. The windshield according to claim 16, wherein
the hinge includes a first flat plate portion connected to the upper panel, a second flat plate portion connected to the lower panel, and a coupling portion coupling the first flat plate portion and the second flat plate portion to each other such that the first flat plate portion and the second flat plate portion are allowed to be folded or unfolded, and
in a state where the upper panel and the lower panel are unfolded, the coupling portion is bent, and the first flat plate portion and the second flat plate portion are folded.
